(19) United States
(12) Patent Application Publication
(10) Pub. No.: US 2012/0024976 A1
(43) Pub. Date: Feb. 2, 2012

(54) LEAK DETECTOR USING ATOMIZED OIL PRODUCED BY A MECHANICAL GENERATING MEANS

(75) Inventors: Larry Betcher, Northfield, MN (US); Stanley Norland, Blooming Prairie, MN (US)

(73) Assignee: SPX Corporation, Charlotte, NC (US)

(21) Appl. No.: 12/846,136

(22) Filed: Jul. 29, 2010

(51) Int. Cl. B05B 17/00; B05B 7/00

(52) U.S. Cl. 239/8; 239/332

(57) ABSTRACT

A visible vapor generator is provided. The visible vapor generator may include: a pump having an inlet and an outlet; and a passage configured to provide a fluid to an impeller associated with the pump in addition to lubricating fluid and working fluid provided to the pump; wherein the action of the impeller atomizes both at least some of both the lubricating fluid and the fluid provided to the impeller and expels the atomized fluid through the outlet. A method of generating a vapor may also be provided. The method may include; modifying a pump to have a passage to conduct fluid to an impeller associated with the pump in addition to the lubricating fluid and working fluid.

### FIELD OF THE INVENTION

The present invention relates generally to a system for generating smoke. More particularly, the present invention relates to a method and apparatus for generating a visible vapor which may commonly be referred to as smoke.

### BACKGROUND OF THE INVENTION

When servicing components of an automobile, one common task is to find leaks in a closed system such as an engine or other components. Current leak detecting system utilizes a smoke or atomized mineral oil where the mineral oil is turned into smoke or atomized by use of a heating element. The smoke is then pumped into the closed system and any leaks will be visible to the naked eye, because the smoke will be seen coming from the leak in the system.

Accordingly, it is desirable to provide a method and apparatus that can generate a visible vapor or “smoke” that can be inserted under pressure into a closed system for detecting leaks.

### SUMMARY OF THE INVENTION

The foregoing needs are met, to a great extent, by the embodiments of the invention, wherein in one aspect an apparatus is provided that in some embodiments a method or apparatus is provided for producing a visible fluid (smoke) and pressuring the smoke to pump the smoke into a system to detect leaks.

In accordance with one embodiment of the present invention, a visible vapor generator is provided. The visible vapor generator may include: a pump having an inlet and an outlet; and a passage configured to provide a fluid to an impeller associated with the pump in addition to lubricating fluid and working fluid provided to the pump; wherein the action of the impeller atomizes both at least some of both the lubricating fluid and the fluid provided to the impeller and expels the atomized fluid through the outlet.

In accordance with another embodiment of the present invention, a visible vapor generator is provided. The visible vapor generator may include; a means for generating pressure having an inlet and an outlet; and a means for providing fluid communication to the pressure generating means in addition to lubricating fluid provided to the pressure generating means; wherein the action of the pressure generating means atomizes at least some of both the lubricating fluid and the fluid provided to the impeller and expels the atomized fluid through the outlet.

In accordance with yet another embodiment of the present invention, a method of generating a vapor is provided. The method may include; modifying a pump to have a passage to conduct fluid to an impeller associated with the pump in addition to the lubricating fluid and working fluid.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a pump that has been modified in accordance to an embodiment of the present invention.

FIG. 2 is an exploded perspective view of a portion of the pump shown in FIG. 1 that has been modified according to an embodiment in accordance with the invention.

FIG. 3 is a cross-sectional view of a rotary vane vacuum pump that has been modified in accordance with the embodiment of the invention.

FIG. 4 is a cross-sectional view of a portion of a rotary vane vacuum pump taken along the line of 4-4 as shown in FIG. 5.

FIG. 5 an exploded view of a portion of a rotary vane vacuum pump that has been modified in accordance with an embodiment of the invention.

### DETAILED DESCRIPTION

According to some embodiments of the invention a visible vapor commonly referred herein to as “smoke” is generated for use in leak detection. While the term “smoke” is commonly used herein, it should be understood that in accordance with several embodiments of the invention, there is no combustion or addition of heat associated with the generation of the visible vapor or smoke.

The term “smoke” as used herein refers to a visible vapor and is not limited to results of a combustion process. An apparatus may be made in accordance with the invention or other apparatus may be adapted such as a rotary vane pump, for example, to generate a desired amount of smoke in accordance with the invention.

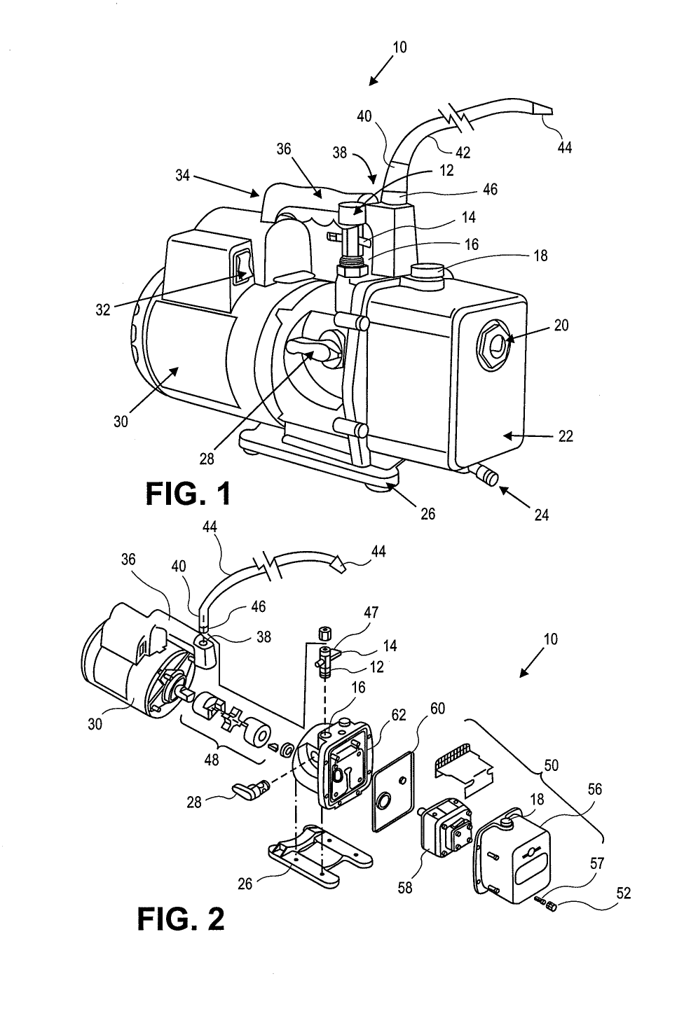

FIG. 1 shows a rotary vane pump that has been adapted or modified to produce a desired amount of smoke in accordance with an embodiment of the invention. The pump 10 includes an intake fitting 12. The intake fitting 12 includes a metering valve 12. Examples of a metering valve 12 may include, but are not limited to a needle valve, a solenoid valve or other control valve. The needle valve 14 can be controlled and/or adjusted to provide a desired intake opening. For example, in accordance with some embodiments of the invention the desired intake opening is about 0.06 of an inch in diameter. The needle valve 14 is located at the intake 16.

An oil fill port 18 is included to permit a user to add lubricating oil to the pump 10. In accordance with some embodiments of the invention the lubricating oil is mineral oil. A sight glass 20 permits a user to see how much oil is in the reservoir filled by the oil fill port 18. The pump 10 includes a housing 22. A drain 24 permits the lubricating oil to be drained for purposes of maintenance or any other reason.

The pump 10 includes a base 26 for supporting the pump 10. An isolation valve 28 is shown in the smoke generating pump 10, however, the isolation valve is not a necessary component of the invention. The isolation valve 28 can optionally allow the system being serviced by the pump 10 to be isolated from the ambient conditions. Pump 10 includes a high torque motor 30. The high torque motor 30 is contained within the housing 22 of the pump 10, but is located generally where the reference numeral 30 indicates. The pump 10 includes a power switch 32 which allows the pump 10 to be turned on or off by a user.

The pump 10 shown in FIG. 1 includes a through the handle exhaust system 34. The pump 10 exhausts the working fluid (a.k.a. pumped fluid) through the handle 36. The handle 36 includes an exhaust port 38. In other embodiments the working fluid is not exhausted through the handle. Rather, the exhaust port 38 is located at a different location on the pump 10. In accordance to some embodiments of the invention, the exhaust port 38 is equipped with an exhaust fitting 40. The exhaust fitting 40 permits the connection of a hose 42 to the exhaust port 38 in order to direct the exhausted working fluid through the hose 42.

In some embodiments of the invention, the visible smoke will be generated in the working fluid that is exhausted by the pump 10. The smoke can be directed through the hose 42. The hose 42 includes a hose fitting 44. The hose fitting 44 allows the hose 42 to be connected to a system that is to be tested for leaks or any other system where it is desired to insert the exhausted working fluid from the pump 10.

A pressure switch 46 where it is located near the exhaust port 38 and may be configured to monitor pressure of the working fluid which may include the smoke exiting the exhaust port 38. In some embodiments of the invention, the pressure switch 46 monitors the gauge pressure of the fluid exhausted through the pump 10.

As shown in FIG. 2 and explained later below, the pressure switch 46 maybe operably connected to a solenoid 47 which operates the needle valve 14. The pressure switch 46 may operate the needle valve 14 via the solenoid 47 in accordance with the pressure detected by the pressure switch 46.

FIG. 2 illustrates a portion of pump 10 in an exploded condition. While many features of a pump 10 are well known or described above, they are described below in detail. However, some features which are new or modified to allow the pump 10 to generate smoke in accordance to the embodiment of the invention will be described in additional detail.

As shown in FIG. 2, the pump 10 includes a pressure switch 46 operatively connected to a solenoid 47. The solenoid 47 is operatively connected to the needle valve 14. According to some embodiments of the invention, the orifice associated by the needle valve 14 allowing air to be sucked into the pump 10 is about 0.06 inches in diameter.

In some embodiments this size can be enlarged or made smaller by the manipulation of the needle valve 14 by either the solenoid 47 or a user. The nominal size of 0.06 inches size can be modified according to the needs of an individual application. If the pressure of the working fluid exiting through the exhaust port 38 is too great, the pressure switch 46 may cause the solenoid 47 to control the needle valve 14 reduce to size of the orifice or even to completely close the needle valve 14 thereby not letting any additional air be sent into the pump via the intake 16.

An algorithm for operating the solenoid 47 in response to the measured pressure may be determined by a user or may be preprogrammed into a microcontroller by the manufacturer. In accordance to some embodiments of the invention, if the pressure of the working fluid exiting the exhaust port 38 exceeds one-half PSI or about 15 inches of water, the needle valve 14 will be moved to a completed closed position.

FIG. 2 shows a drive train assembly 48 which operatively connects the motor 30 to an impeller (not shown in FIG. 2). A module assembly 50 is also shown. A module assembly 50 may include an oil drain cap 52, an oil drain kit 54, a module cover 56, and a module 58. These parts will not be explained in detail as they are not particularly relevant to certain embodiments in accordance with the invention.

A plate 60 is located between the module assembly 50 and the rotary pump portion 62. The rotary pump portion 62 receives the intake fitting 12 containing the needle valve 14 at the intake 16 and portion is supported by the base 26 and receives the isolation valve 28. The handle 36 is located near the motor 30 and includes the exhaust port 38 and the exhaust fitting 12. The exhaust fitting 12, as described above, accepts the hose 42 which may in some embodiments include a nozzle or fitting 44. While the pump 10 has been shown as one example embodiment of the invention, it is certainly not intended to be limiting. Other layouts maybe used including those that do not include a through the handle exhaust system 34.

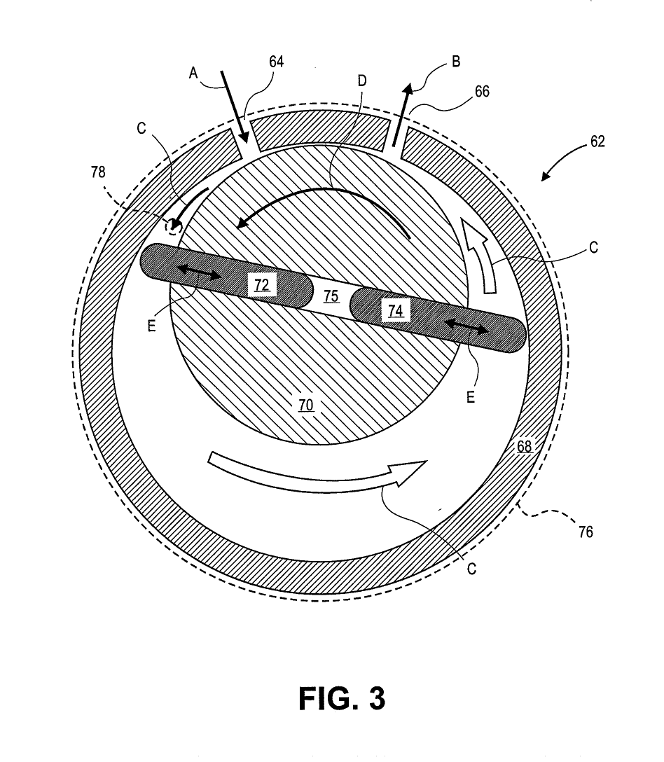

FIG. 3 is a cross-section of a rotary vane pump portion 62 that may be used in accordance with some embodiments of the invention. The rotary vane pump portion 62 may include an inlet 64, an outlet 66, and housing 68. A rotor 70 includes multiple vanes 72 and 74. The vanes 72 and 74 maybe biased to an outward position by a spring 75. The vanes 72 and 74 may move in and out as indicated by arrows E. The vanes 72 and 74 are biased to the outward position. Outward being described as urging against the housing 68.

In accordance with some embodiments of the invention, an end plate 76 together with the housing 68 encloses the pump 62. The end plate 76 is shown in phantom lines and is shown as a “see through” object in order to allow the parts such as the rotor 70 and vanes 72 and 74 and spring 76 along with the housing 22 to be shown. The end plate 76 may include an orifice or opening 76 which may allow a fluid other than the working fluid to be introduced to the mechanical features of the pump. The fluid that maybe introduced is atomized by the working action of the pump mixed in with the working fluid and is expelled out the outlet 66.

The rotary vane pump maybe operated in a manner as described below. A rotor 70 is rotated in the direction as shown in by arrow D. Working fluid which maybe air is input into the inlet 64 shown by arrow A by the operation of the pump. As the rotor 70 rotates the direction of arrow D, the spring 75 urges the vanes 72 and 74 in an outward position. As vanes 72 and 74 move the working fluid in the direction of arrow C the working fluid is moved creating a suction at the inlet 64. Which causes additional working fluid such as air to enter the inlet 64.

As the rotor 70 continues to rotate, the vane 72 and 74 are continued to be urged in an outward direction and held by the housing 22. The working fluid continues to moved in the directions of arrow C where it eventually exits through the outlet 66 in direction of B.

Rotary pumps 62 may include a lubricating fluid to allow lubrication between the vanes 72 and 74 and the housing 22 and the rotor 70. In some embodiments, the fluid maybe mineral oil. In other embodiments, other fluid may be used. The action of the rotor 70, the vanes 72 and 74, and the housing 22 atomizes a certain amount of the lubricating oil causing it to become a visible vapor. Therefore, when the working fluid exits out the outlet 66 it also contains visible vapor which is atomized lubricating oil. However, in accordance to some embodiments of the invention, an additional amount of visible vapor is desired in addition to what is generated by the atomization of the lubricating fluid. Therefore, additional fluid is provided via the orifice 78 in order for it to also be atomized. Therefore, when the working fluid exits the outlet 66 additional visible vapor is contained in the working fluid and maybe seen.

In some embodiments of the invention, the orifice 78 may provide a fluid passage from the lubricating oil reservoir to the rotor 70 and the vanes 72 and 74. The orifice 78 provides a way for fluid to contact the vanes 72 and 74, the rotor 70 to and the housing 22 in addition to the regular lubricating pathway the lubricating fluid.

In some embodiments of the invention, the orifice 78 maybe about 0.002 inches in diameter. Other embodiments may include a separate reservoir then the regular reservoir of lubricating fluid for of fluid providing additional fluid to be exposed to the working features of the pump to be atomized.

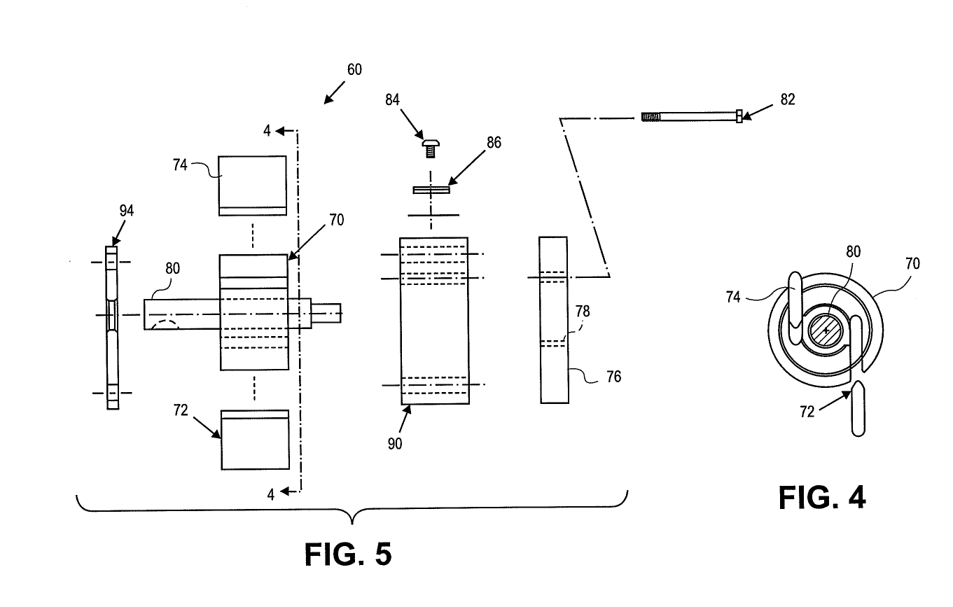

FIG. 4 shows an end view of a rotor 70 according to another embodiment of the invention. The rotor 70 has vanes 72 and 74 which are not actually aligned as shown in FIG. 3. The rotor 70 is mounted to a shaft 80 and contains vanes 72 and 74.

FIG. 5 is an exploded side view of a rotary pump 62 modified to in accordance with another embodiment of the invention similar to that shown in FIG. 4. As shown in FIG. 5, an end plate 76 includes an orifice 78. The orifice 78 may permit fluid to be exposed to the working features of the pump 62 similar to the orifice 78 described with respect to FIG. 3. When the pump 62 is assembled, the end plate 76 is held tightly against the pump housing 22 by a screw 82. The pump housing 90 may include a reed valve or a limiter 86 held in place by a screw 84. The shaft 80 may support the rotor 70 which supports the vanes 72 and 74. The shaft 80 may also be held in place by an inlet plate 94. The shaft 80 may extend through the inlet plate 94 and may attach to a motor for turning the shaft 80.

Additional details regarding the pump are not shown or described as they are not particularly relevant to the invention and may be already known in the art. While the examples listed here have discussed rotary vane pumps for atomizing a fluid. Other types of pumps maybe used. In accordance with some embodiments of the invention a typical pump maybe modified to include an orifice or hole for providing additional fluid to the mechanical moving parts of the pump in order to provide additional fluid to be atomized in addition to any lubricating fluid that may be atomized by the mechanical action of the pump. The atomized fluid in the form of a visible vapor or smoke may be mixed with the working fluid of the pump and exhausted out of the pump via the outlet. This pressurized visible fluid may then be used for leak detection or any other desired purpose.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A visible vapor generator comprising:
a pump having an inlet and an outlet; and
a passage configured to provide a fluid to an impeller associated with the pump in addition to lubricating fluid and working fluid provided to the pump; wherein the action of the impeller atomizes both at least some of both the lubricating fluid and the fluid provided to the impeller and expels the atomized fluid through the outlet.

2. The generator of claim 1, further comprising a conduit attached to the outlet for directing the atomized fluid.

3. The generator of claim 2, wherein the hose is fitted with a nozzle.

4. The generator of claim 1, wherein the pump is a vacuum pump.

5. The generator of claim 1, wherein the inlet is controlled by a valve.

6. The generator of claim 5 wherein the valve is a metering valve.

7. The generator of claim 5 further comprising a pressure switch operatively connected to the outlet to detect a gage pressure associated with fluid exiting the outlet, the pressure switch operatively connected to the valve at the inlet to control the valve according to a detected gage pressure at the outlet.

8. The generator of claim 7 wherein when the detected gage pressure exceeds 0.5 psi, the pressure switch closes the metering valve.

9. The generator of claim 1, wherein the passage is a orifice of about 0.002 of an inch in diameter.

10. The generator of claim 1, wherein the inlet is about 0.06 of in inch in in diameter.

11. The generator of claim 1, wherein the fluid provided to the impeller is mineral oil.

12. The generator of claim 11 wherein the lubricating fluid is also mineral oil.

13. A visible vapor generator comprising:
a means for generating pressure having an inlet and an outlet; and
a means for providing fluid communication to the pressure generating means in addition to lubricating fluid provided to the pressure generating means; wherein the action of the pressure generating means atomizes at least some of both the lubricating fluid and the fluid provided to the impeller and expels the atomized fluid through the outlet.

14. A method of generating a vapor comprising:
modifying a pump to have a passage to conduct fluid to an impeller associated with the pump in addition to the lubricating fluid and working fluid.

15. The method of claim 14, further comprising providing a fluid to the impeller via the passage.

16. The method of claim 15, wherein the fluid is mineral oil.

17. The method of claim 14, wherein the passage is about 0.020 of an inch in diameter.

18. The method of claim 14, further comprising restricting the inlet to the pump to be about 0.06 of an inch in diameter.

19. The method of claim 14, further comprising monitoring the gage pressure of the outlet and controlling the size of the inlet based on the outlet gage pressure.

20. The method of claim 14, further comprising attaching a hose to the outlet.
